(19) United States
(12) Patent Application Publication
(10) Pub. No.: US 2004/0133424 A1
(43) Pub. Date: Jul. 8, 2004

(54) Processing speech signals

(76) Inventors: Douglas Ralph Ealey, Southampton (GB); Holly Louise Kelleher, Guilford (GB); David John Benjamin Pearce, Basingstoke (GB)

Correspondence Address: MOTOROLA, INC., 1303 EAST ALGONQUIN ROAD, IL01/3RD, SCHAUMBURG, IL, 60196

(21) Appl. No.: 10/475,641

(22) PCT Filed: Apr. 22, 2002
(86) PCT No.: PCT/EP02/04425

(30) Foreign Application Priority Data
Apr. 24, 2001 (GB) 0110068.4

(51) Int. Cl. G10L 11/04; G10L 15/20; G10L 15/00

(52) U.S. Cl. 704/233; 704/207

(57) ABSTRACT

A method of processing a speech signal in noise, comprising: determining a frequency spectrum of a frame of the speech signal; determining a value of the pitch of the frame of the speech signal; identifying peakes (12, 14, 16, 22, 28, 32) in the spectrum; and evaluating the peaks individually to determine respective scores for the peaks, the score for a peak being a measure of the likelihood that the peak is a harmonic band of teh speech signal. As a consequence there is: (a) no need for high f0 accuracy as there is no need to predict long sequences of harmonic positions; and (b) no need for an assumption of harmonic integrity at all points.

### FILED OF THE INVENTION

This invention relates to processing speech signals in noise. The invention may be used in, but is not limited to, the following processes: automatic speech recognition; front-end processing in distributed automatic speech recognition; speech enhancement; echo cancellation; and speech coding.

### BACKGROUND OF THE INVENTION

In the field of this invention it is known that voiced speech sounds (e.g. vowels) are generated by the vocal chords. In the spectral domain the regular pulses of this excitation appear as regularly spaced harmonics. The amplitudes of these harmonics are determined by the vocal tract response and depend on the mouth shape used to create the sound. The resulting sets of resonant frequencies are known as formants.

Speech is made up of utterances with gaps therebetween. The gaps between utterances would be close to silent in a quiet environment, but contain noise when spoken in a noisy environment. The noise results in structures in the spectrum that often cause errors in speech processing applications such as automatic speech recognition, front-end processing in distributed automatic speech recognition, speech enhancement, echo cancellation, and speech coding. For example, in the case of speech recognisers, insertion errors may be caused. The speech recognition system tries to interpret any structure it encounters as being one of a range of words that it has been trained to recognise. This results in the insertion of false-positive word identifications.

Clearly this compromises performance, and in context-free speech scenarios (such as voice dialling or credit card transactions), spurious word insertions are not only impossible to detect but invalidate the whole utterance in which they occur. It would therefore be desirable to have the capability to screen out such spurious structures at the outset.

Within utterances, noise serves to distort the speech structure, either by addition to, or subtraction from, the ‘original’ speech. Such distortions can result in substitution errors, where one word is mistaken for another. Again, this clearly compromises performance. Identifying which components of a speech utterance are likely to be truly speech can alleviate this problem.

Conventional speech enhancement methods use ‘pitch’ detection, where pitch is defined as the fundamental excitation frequency of the speech, f₀. Upon obtaining an estimate of this value, it is then assumed that speech harmonics (multiples of f₀) are equidistant, to identify them within the noise and so isolate the speech.

However, a weakness of such methods is that inaccuracies and/or imprecision in the estimation of the value of f₀ are compounded as this value is used to locate the harmonics. The accuracy/precision in the frequency domain may be considered in terms of frequency bins. A frequency bin represents the smallest unit, i.e. maximum resolution, available in the frequency domain after the speech signal has been transformed into the frequency domain, for example by undergoing a fast Fourier transform (FFT). The accuracy of f₀, required to predict the positions of, say, 20 multiples to within one frequency bin, is very hard to achieve using short time slices, e.g. speech recognition sampling frames, of the order of 10 msec.

However, this is required in order to identify the whole of the speech contribution to the spectrum. Using longer sample frames (i.e. time slices) is often impractical as it introduces delay. Furthermore f₀ is constantly changing in time, making longer time averages inaccurate as harmonic effects occur if a sliding pitch is used to calculate f₀ for a single speech spectrum.

Also, the conventional methods assume that all values at each harmonic should be treated equally, but this approach tends to fail in noise. Simply given a series of positions within the spectrum, it is impossible to state what proportion of each value at each position is due to speech or noise. As a result, such methods are forced to incorporate significant noise into their speech estimates.

Thus, there exists a need in the field of the present invention to provide a method for distinguishing speech from noise within an utterance.

Known Prior Art Documents:

U.S. Pat. No. 5,313,353 (THOMSON CSF) allocates a score to peaks on the basis of peak strength. For the purposes of the Thomson patent it is reasonable to assume that a strong peak is a harmonic peak. However, the emphasis of this current invention is the determination of speech signals in noisy conditions, where one is no longer able to assume that a strong peak is likely be speech, and consequently the alternative strategies described herein are used to gauge likelihood.

U.S. Pat. No. 5,321,636(PHILLIPS CORP) The patent is concerned with how people perceive the interactions of two or more separately sourced tonal signals, and assumes knowledge of their position in the frequency spectrum. The correlation of sample frequency positions with these two tones are evaluated to class them as being associated with one or other of the tones. By contrast, this current invention is concerned with the determination of speech and makes no assumptions about the position or existence of tonal (specifically, voiced) signals. Moreover the current invention seeks to evaluate each signal instance by reference to values at expected positions, rather than taking known signals and associating chosen test values with them.

### SUMMARY OF INVENTION

In a first aspect, the present invention provides a method of processing a speech signal in noise, as claimed in claim 1.

In a second aspect, the present invention provides a method of performing automatic speech recognition on a speech signal in noise, as claimed in claim 28.

In a third aspect, the present invention provides a method of identifying peaks in a frequency spectrum of a speech signal frame, as claimed in claim 29.

In a fourth aspect, the present invention provides a storage medium storing processor-implementable instructions, as claimed in claim 30.

In a fifth aspect, the present invention provides apparatus, as claimed in claim 31.

Further aspects are as claimed in the dependent claims.

The present invention alleviates the above described disadvantages by determining peaks in the frequency spectrum of a speech signal in noise and then identifying which of these peaks are, or are likely to be, harmonic bands of the speech signal. Although some use is made of the value of the pitch f₀, imprecision or inaccuracy in this value does not preclude a more accurate location of the positions of the harmonics.

### BRIEF DESCRIPTION OF THE DRAWINGS

Embodiments of the present invention will now be described, by way of example only, with reference to the accompanying drawings, in which:

FIG. 1 is a block diagram of an apparatus used for implementing embodiments of the present invention;

FIG. 2 is a flowchart showing the process steps carried out in a first embodiment of the present invention;

FIG. 3 shows a typical spectrum provided by a fast Fourier transform of a sample frame of speech;

FIG. 4 shows an exemplary peak schematically representing each of the peaks shown in FIG. 3;

FIG. 5 is a flowchart showing step s10 of FIG. 2 broken down into constituent steps in a first embodiment;

FIGS. 6A and 6B illustrate aspects of a scoring system employed in the process of FIG. 5;

FIG. 7 is a flowchart showing step s10 of FIG. 2 broken down into constituent steps in a second embodiment;

FIGS. 8A-8C show implementation of a mask for scoring time consistency in a further embodiment;

FIGS. 9A and 9B show, respectively, a typical log spectrum and a corresponding root spectrum; and

FIGS. 10A-10E illustrate spectrograms showing results of implementing the present invention.

### DESCRIPTION OF PREFERRED EMBODIMENTS

FIG. 1 is a block diagram of an apparatus 1 used for implementing the preferred embodiments, which will be described in more detail below. The apparatus 1 comprises a processor 2, which itself comprises a memory 4. The processor 2 is coupled to an input 6 of the apparatus 1, and an output 8 of the apparatus 1.

In this embodiment the apparatus 1 is part of a general purpose computer, and the processor 2 is a general processor of the computer, which performs conventional computer control procedures, but in this embodiment additionally implements the speech processing procedures to be described below.

To do this, the processor 2 implements instructions and data, e.g. a program, stored in the memory 4. In this embodiment, the memory 4 is a storage medium, such as a PROM or computer disk. In other embodiments, the processor may be specifically provided for the speech processing processes to be described below, and may be implemented as hardware, software or a combination thereof.

Similarly, the apparatus 1 may be a stand-alone apparatus, or may be formed of various distributed parts coupled by communications links, such as a local area network. The apparatus 1 may be adapted for automatic speech recognition, front-end processing in distributed automatic speech recognition, speech enhancement, echo cancellation, and speech coding, in which case the apparatus may be part of a telephone or radio. In the case of front-end processing in distributed automatic speech recognition, the apparatus may also be part of a mobile telephone.

Speech data processed according to the following embodiments may be transmitted to the back-end of the distributed automatic speech recognition system in the form of a carrier signal by any suitable means, e.g. by a radio link in the case of a mobile telephone, or by a landline in conventional computer application. Likewise, for example, in the case of speech coding, speech data that is processed according to the following embodiments, and then speech coded, may be transmitted in the form of a carrier signal by any suitable means, e.g. by a radio link in the case of a mobile telephone, or by a landline in conventional computer application.

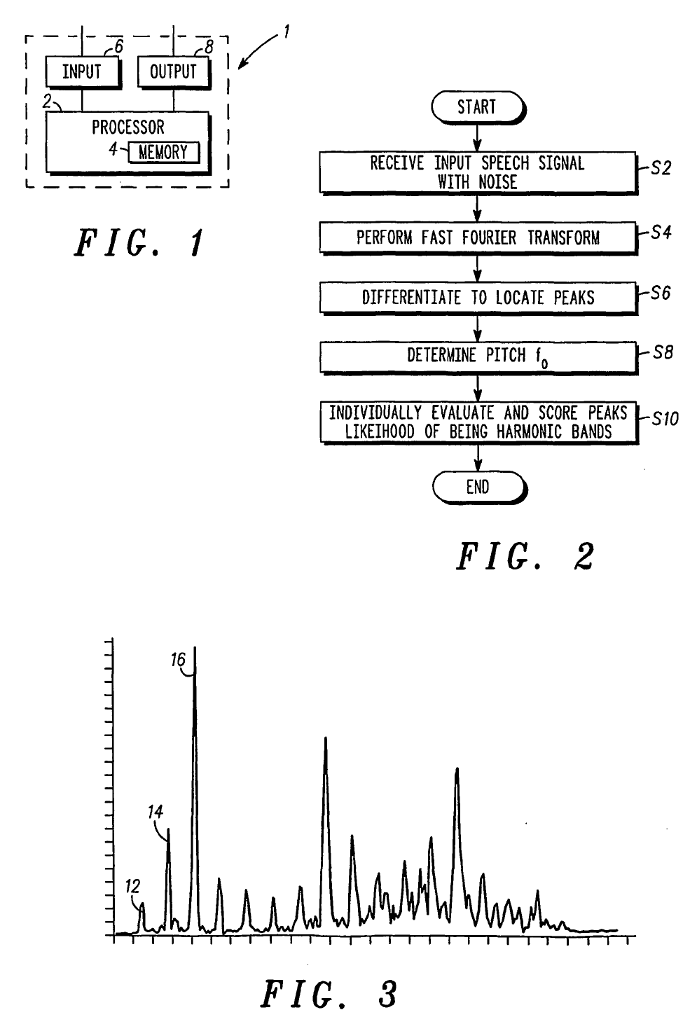

The process steps carried out by the apparatus 1 when performing the speech processing procedure of a first embodiment are shown in FIG. 2. At step s2, the apparatus 1 receives an input speech signal containing noise.

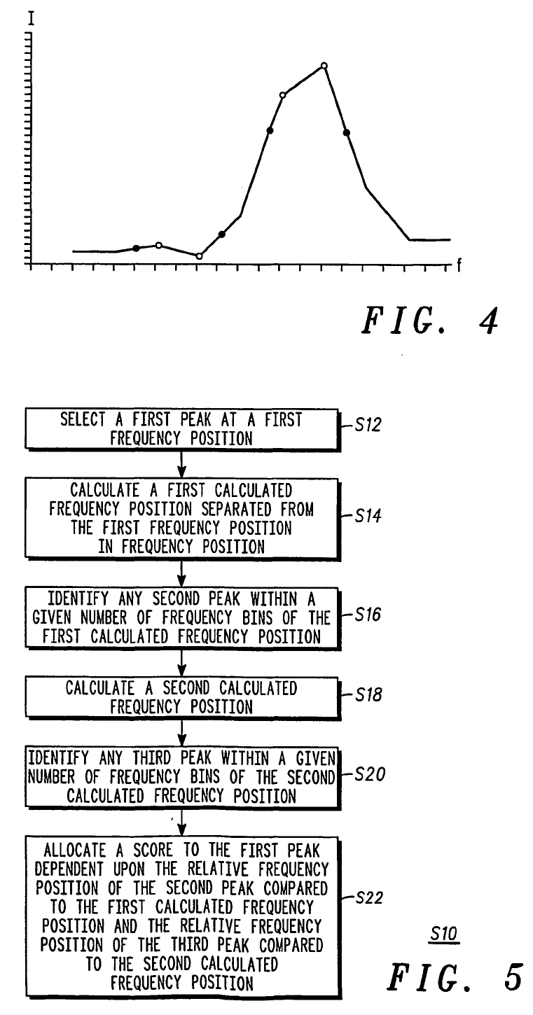

At step s4, the apparatus 1 performs a fast Fourier transform (FFT) on time frame, which in this embodiment is of 10 msec duration, of the input signal to provide a frequency spectrum of that frame of the signal. A typical spectrum is shown in FIG. 3. In FIG. 3, the abscissa represents frequency in frequency bins and the ordinate represents intensity of the signal sample at the corresponding frequency. A plurality of peaks, such as peaks 12, 14, 16 can readily be seen.

At step s6, the apparatus 1 differentiates the spectrum to locate peaks thereof, i.e. the local gradient of the spectrum is evaluated. This may be performed in conventional fashion, but in this embodiment a modification to the conventional method, two separate scales, is employed, as will now be explained with reference to FIG. 4, which shows an exemplary peak schematically representing each of the peaks (e.g. 12, 14, 16) shown in FIG. 3. The gradient is evaluated over two scales, for example a first scale of 5 frequency bins and a second scale of 3 frequency bins. The purpose is to discriminate in favour of significant (speech) peaks using the larger scale, and use a fractionally weighted contribution from the smaller scale differentiation to resolve the precise position of the peak.

In FIG. 4, the large-scale differentiation is indicated by filled circles, and the small-scale differentiation is indicated by open circles. The large-scale differentiation is given twice the weighting of the small-scale differentiation. Thus, between the two filled circles on the left of FIG. 4, the overall gradient remains positive, ignoring the minor feature, whilst between the two filled circles on the right of FIG. 4, the large-scale differentiation reveals the existence of a peak, and the small-scale differentiation more precisely indicates the position of the peak. The use of two scales serves to positively discriminate in favour of speech peaks before any other structural analysis takes place. The benefit of employing this two-scale differentiation process may be further appreciated by reference to the Results section below.

At step s8, the apparatus 1 determines the pitch f₀ of the speech sample. This may be performed in conventional fashion using autocorrelation in the frequency domain. Alternatively this may be performed in conventional fashion using autocorrelation in the time domain. In this embodiment, a modification to conventional frequency domain autocorrelation is employed, as follows. To minimise computational cost, only the first 800 Hz of the spectrum is analysed, as this has been found to usually contain sufficient harmonics for a sufficiently accurate autocorrelation.

To improve pitch estimation accuracy, the differentiation method discussed above was employed to find all peaks in the autocorrelation sequence, with the highest harmonic found (peak 12 in FIG. 3) being used to estimate the pitch. This method means that the accuracy of the pitch is inversely proportional to its period. Hence, low-pitch talkers (who will have more harmonics and so need greater accuracy) will gain proportionately more accurate pitch estimation than high-pitch talkers, making the accuracy-per-harmonic consistent for all talkers.

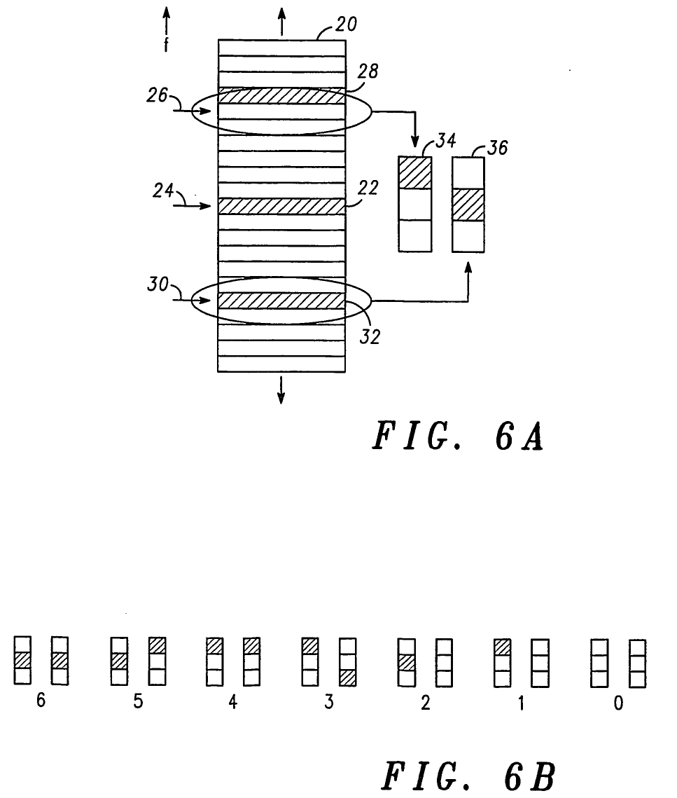

At step s10, identified peaks are individually evaluated and scored for their likelihood of being harmonic bands of the speech content of the speech signal in noise. Every candidate peak is given a score according to how closely its neighbouring peaks fit the calculated pitch. Step s10 will now be described in further detail with reference to FIG. 5 which is a process flowchart showing step s10 broken down into constituent steps, and FIGS. 6A and 6B which illustrate aspects of the scoring system employed in this embodiment.

Referring to FIG. 5, at step s12, the apparatus selects a first (i.e. candidate) peak at a first frequency position (the term “first” is used here, and the terms “second” and “third” are used below, to label peaks and frequency positions with respect to the other peaks and frequency positions, and are not to be considered as significant in any physical sense). The position of various peaks is shown schematically in FIG. 6A, where a succession of frequency bins is represented in a column structure 20, with the first peak 22 at a first frequency position 24 indicated by an arrow.

At step s14, the apparatus 1 calculates a first calculated frequency position 26 separated from the first frequency position in frequency by the pitch value. In this example the pitch is calculated to be equal to 6 frequency bins, and hence in FIG. 6A the first calculated frequency position 26 is, as indicated by another arrow, six bins higher than the first frequency position 24.

At step s16, the apparatus 1 identifies any peak (hereinafter referred to as a second peak) within a given number of frequency bins of the first calculated frequency position 26. In this embodiment the given number is ‘1’. Hence, the apparatus identifies if there is any peak at ‘±1’ bin within the first calculated frequency position 26. As can be seen in FIG. 6A, in this example such a second peak 28 is present, and hence identified, at the frequency bin that is ‘+1’ compared to the first calculated frequency position 26.

At step s18, the apparatus 1 calculates a second calculated frequency position 30 separated, in the opposite frequency direction to the first calculated frequency position, from the first frequency position in frequency by the pitch value. As shown in FIG. 6A, the second calculated frequency position 30 is, as indicated by another arrow, six bins lower than the first frequency position 24.

At step s20, the apparatus 1 identifies any peak (hereinafter referred to as a third peak) within a given number of frequency bins (here ‘±1’ bin) of the second calculated frequency position 30. As can be seen in FIG. 6A, in this example such a third peak 32 is present, and hence identified, at the frequency bin which is at the second calculated frequency position 30.

At step s22, the apparatus 1 allocates a score to the first peak dependent upon: the relative frequency position (bin) of the second peak compared to the first calculated frequency position, and the relative frequency position (bin) of the third peak compared to the second calculated frequency position. In this embodiment this is done such that the score is allocated according to:

(a) the closeness of the second peak 28 to the first calculated frequency position 26,

(b) the closeness of the third peak 32 to the second calculated frequency position 30, and

(c) whether any variation is in the same or different frequency direction for the second peak 28 compared to the third peak 32.

More particularly, since in this embodiment the given number of frequency bins from the first and second calculated frequency positions within which any second or third peak is identified is ‘±1’ bin, the second and third peaks if identified can each only be either (i) one bin higher, (ii) at the correct bin or (iii) one bin lower than the respective calculated frequency position. It is also useful to bear in mind: (iv) if no peaks are identified within ± one frequency bin then there is no respective identified peak.

In the example of FIG. 6A, the second peak 28 is one bin higher than its corresponding calculated frequency position (the first calculated frequency position 26), i.e. (i) above applies, as represented graphically in FIG. 6A by a column 34 of three blocks having its top block (representing ‘+1’ ) filled in. Furthermore in the example of FIG. 6A, the third peak 32 is at the correct bin compared to its corresponding calculated frequency position (the second calculated frequency position 30), i.e. (ii) above applies, as represented graphically in FIG. 6A by a column 36 of three blocks having its middle block (representing parity) filled in. For the sake of completeness, it is noted that under this graphical representation, if (iii) above were to apply then a column of three blocks having its bottom block (representing ‘−1’) filled in would be shown. If (iv) above were to apply then a column of three blocks with none of the blocks filled in would be shown.

The score is allocated according to a scoring system, which in this embodiment has seven different levels set at the values of ‘0’ to ‘6’ inclusive. This scoring system is shown graphically in FIG. 6B in terms of the three-block columns such as 34, 36 described above. It will be appreciated that in other embodiments other relative values (e.g. non-linear) may be assigned to the seven levels, or indeed other logical levels may be defined.

If both the peaks are at the correct bin, the score is ‘6’;

if one of the peaks is at the correct bin and the other peak is one bin higher or one bin lower, the score is ‘5’;

if both peaks are one bin higher or both peaks are one bin lower, the score is ‘4’;

if one peak is one bin higher and the other peak is one bin lower, the score is ‘3’;

if one peak is correct and there is no other peak identified, the score is ‘2’;

if one peak is one bin higher or one bin lower, and there is no other peak identified, the score is ‘1’; and

if neither peak is identified, the score is ‘0’.

It can be seen from FIG. 6B that deviation from the expected position is scored both in terms of absolute distance and consistency within the local sequence of three peaks.

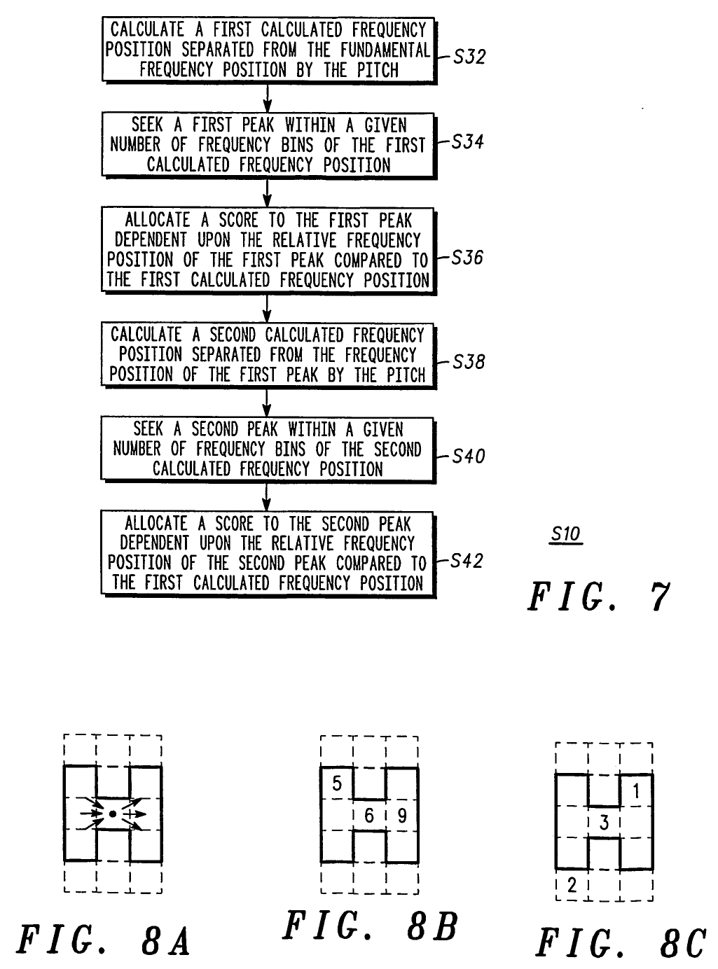

In a second embodiment of the invention, steps s2 to s8 are carried out as for the first embodiment. However, step s10 (in which identified peaks are individually evaluated and scored for their likelihood of being harmonic bands of the speech content of the speech signal in noise) is implemented in a different manner that will now be described with reference to FIG. 7. FIG. 7 is a process flowchart showing constituent steps of s10 according to this second embodiment.

At step s32, the apparatus 1 calculates a first calculated frequency position separated from the fundamental frequency position by the pitch. At step s34, the apparatus seeks a first peak within a given number of frequency bins (in this example within ‘±1’ bin) of the first calculated frequency position. Again the terminology “first peak”, “second peak” etc. is only used as a label, i.e. it should be borne in mind there is also a peak at the first harmonic frequency (the pitch). If such a first peak is found, at step s36, the apparatus 1 allocates a score to the first peak dependent upon the relative frequency position of the first peak compared to the first calculated frequency position. In this case a score of, say, ‘4’ if the first peak is at the calculated position or a score of, say, ‘2’ if the first peak is one bin higher or lower than the calculated position.

If only one peak is being investigated, the procedure may be terminated here. However, if optionally one or more further peaks are to be scored, the procedure continues as follows. At step s38, the apparatus 1 calculates a second calculated frequency position separated from the frequency position of the first peak by the pitch. At step s40, the apparatus 1 seeks a second peak within a given number of frequency bins (again, in this example, ‘±1’ bin) of the second calculated frequency position.

If such a second peak is found, at step s42, the apparatus 1 allocates a score to the second peak dependent upon the relative frequency position of the second peak compared to the first calculated frequency position (again a score of ‘4’ or ‘2’, on the same basis as above).

In the above processes if, when seeking a peak within ‘±1’ bin of, say, the first calculated frequency position (step s34), no peak is found, in order to continue the process the following steps may be employed: calculate a second calculated frequency position separated from the fundamental frequency position by twice the pitch; seek a second peak within a given number of frequency bins of the second calculated frequency position; and if such a second peak is found, allocate a score to the second peak dependent upon the relative frequency position of the second peak compared to the second calculated frequency position.

In all stages of the second embodiment, as described above, if the whole frequency range of the spectrum is to be analysed, then the above steps are repeated in corresponding fashion for further peaks and/or multiples of the pitch until the whole spectrum has been analysed.

The above described second embodiment may be summarised as follows. Rather than evaluating every peak, this method starts with the fundamental frequency position and then looks for the next harmonic peak within ±1 in of its expected position. If found, this new peak receives a score of, say, ‘4’ for exact periodicity and ‘2’ for ‘±1’ bin. The process then continues using this new peak as the start position. Where no peak is found, the algorithm looks ‘2’, ‘3’, ‘4’ etc. periods higher until a peak is encountered.

This process discriminates against harmonic structures that are not strictly speech (e.g. ‘creak’, a half-period phenomenon seen in some female talkers) or other background speech, echoes, music etc.

In a third embodiment, the first and second embodiments are effectively used in combination, in that the score for a peak is derived by carrying out the scoring process of the first embodiment and that of the second embodiment and combining the two scores. In this third embodiment the two separate scores are added, but other combinations may be used, for example by multiplying. By employing both scoring methods, genuine speech harmonics can score twice.

A further option is to re-evaluate the value of the pitch using identified harmonics, leading to an iterative process if the improved pitch value is then used in a re-assessment of the harmonics, and so on.

Because it is possible that part of a harmonic sequence is lost in noise, it may originally be necessary to use predictions of small harmonic multiples. As a consequence it is desirable to ensure the estimate of f₀ is as good as possible. In the above embodiments, the initial estimate is made using autocorrelation up to 800 Hz. Consequently, when a peak at a frequency greater than 800 Hz is found to have a maximum score, according to the methods described above, it is used to re-evaluate the pitch period. The frequency value at which it is found is divided by its harmonic number to get a more accurate fractional value of f₀.

A further option is to analyse the scores, provided by any of the above embodiments, for consistency with time, in particular for consistency with scores achieved for a corresponding peak in previous or subsequent, sampled frames. Consistency in both time and frequency requires a two-dimensional analysis of the frequency scores. This approach requires the storage of the peak analyses for the ‘past’, ‘current’ and ‘future’ scores (in effect requiring frame lag) to provide the context with which to evaluate the ‘current’ frame.

Each peak in the current frame is analysed using a ‘mask’ or ‘filter’ implementing a rule that discriminates in favour of allowable frame-to-frame speech harmonic trajectories (i.e. within ‘time-frequency space’ as, for example, in a spectrogram, which will be described in more detail in the Results section below). The new score for the current peak consists of a combination of the scores of all those peaks that fall within the mask.

In a preferred implementation, only the immediately preceding frame and the immediately subsequent frames are considered. The allowable frame-to-frame speech harmonic trajectory is that the corresponding peaks in the previous and subsequent frames are only allowed to be at the same frequency bin or at ‘±1’ frequency bin from the same frequency bin as the peak in the present frame. This is represented graphically in FIG. 8A, where the centre of the H-shape indicates a frequency bin position for a peak under consideration in a present frame. The left-hand side of the H-shape indicates allowable frequency bin positions for a corresponding peak in the preceding frame (i.e. ‘+1’ bin, same bin, and ‘−1’ bin). The right-hand side of the H-shape indicates allowable frequency bin positions for a corresponding peak in the subsequent frame (i.e. ‘+1’ bin, same bin, and ‘−1’ bin).

In this example, the score of a peak in the present frame is modified by adding to it: (i) the score for the corresponding peak in the immediately preceding frame, and (ii) the score for the corresponding peak in the immediately subsequent frame. Two illustrative examples, for the mask of FIG. 8A, will now be described and shown graphically in FIGS. 8B and 8C.

In the first example, as shown in FIG. 8B, the score for the peak in the current frame is ‘6’, as indicated by the score of. ‘6’ in the centre of the H-shape. In the preceding frame the score was ‘5’, and the peak was located one frequency bin higher than in the present frame, hence this score of ‘5’ is present in the top-left hand of the H-shape. This will therefore be added to the score of ‘6’. In the subsequent frame, the score is ‘9’, and the peak is at the same frequency bin as in the present frame. Hence, this score of ‘9’ is present in the centre of the righthand part of the H-shape. This will therefore also be added to the score of ‘6’. Hence, the overall score is ‘6+5+9=20’.

In the second example, as shown in FIG. 8C, the score for the peak in the current frame is ‘3’, as indicated by the score of ‘3’ in the centre of the H-shape. In the preceding frame the score was ‘2’, but the peak was located two frequency bins lower than in the present frame, hence this score of ‘2’ is outside of the H-shape. This will therefore not be added to the score of ‘3’. In the subsequent frame, the score is ‘1’, and the peak is one frequency bin higher than in the present frame, hence this score of ‘1’ is present in the top-right of the H-shape. This will therefore be added to the score of ‘3’. Hence the overall score is ‘3+1=4’.

It can be seen that scores for a given peak will be boosted if the peak is consistent over time, and diminished if the peak is inconsistent over time. This will be the case for either high or low values. However, in the above examples of FIGS. 8B and 8C, higher individual scores were used in the more time consistent example (FIG. 8B), as the inventors have found such a trend for actual speech signals in noise. In other words, noise peaks tend to score poorly in the scoring process of any of the three embodiments described above, and then also fail to fit the mask well. Consequently, when the option of assessing time consistency is employed, the accuracy of the identification of the peaks is even more powerful as the methods re-enforce each other.

The scores derived in the above embodiments may be employed in a number of ways. The score for a peak may be compared to a threshold value to determine whether the peak is to be treated as a harmonic band of the speech signal. Alternatively, the sum of the scores for all of the peaks of the frame may be compared to a threshold value to determine whether the frame is to be treated as speech.

Optionally, a separate conventional speech/non-speech detector, (e.g. based on speech recognition) may be used to estimate whether the frame is speech or non-speech, and the threshold value varied according to whether the estimate is speech or non-speech.

Another alternative is that the speech signal may be reproduced in a form containing only the harmonic bands or frames that are to be treated as speech, in view of the comparison of their score with the threshold.

Yet another alternative is that the score for a peak is used as a speech-confidence indicator for further processing of the peak, again optionally moderated by external speech/non-speech information.

One particular use of the identification of the harmonics, in an automatic speech recognition process, will now be described in more detail.

In accordance with a conventional automatic speech recognition process, input speech is transformed into the frequency domain, thereby providing a frequency spectrum, using for example a conventional FFT process. At a later stage, a non-linear transformation is performed, resulting in a cepstrum, which is used in known fashion during the remainder of the automatic speech recognition process. Conventionally, the non-linear transformation employed is a logarithmic transformation, such that the cepstrum is conventionally a log-cepstrum. In contrast thereto, in this embodiment of the present invention, a root-cepstrum is employed, by performing a root or fractional power non-linear transformation rather than a logarithmic non-linear transformation.

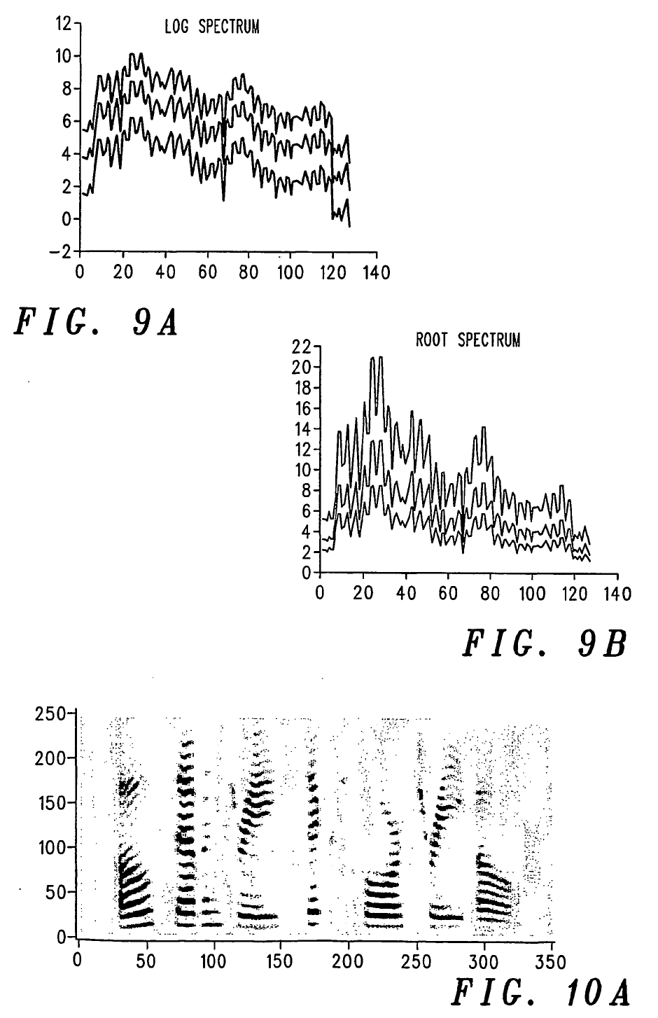

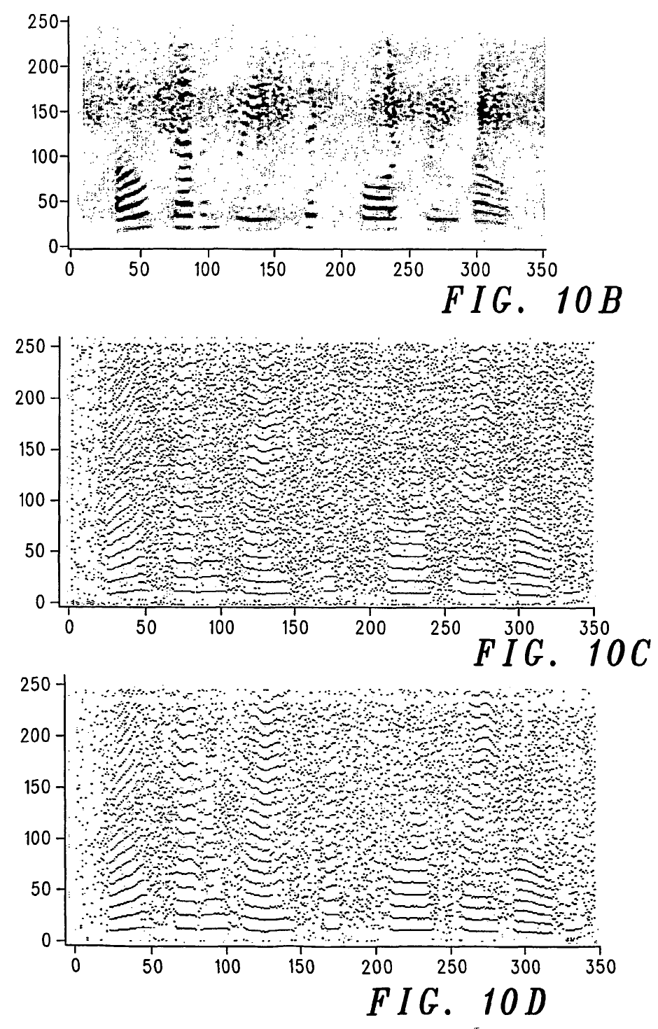

The root-cepstrum has a much larger dynamic range than the log cepstrum, which helps to preserve the speech peaks in the presence of noise (consequently improving recognition). However, it also has a non-linear relationship with speech energy that counteracts this benefit if the energy is not constant. The log-cepstrum is energy invariant in its transformation of the speech, but strongly reduces its dynamic range. This reduces the differentiability of the speech within the recogniser. This dichotomy is illustrated in FIGS. 9A and 9B.

As Cepstra do not lend themselves to straightforward graphical presentation, FIGS. 9A and 9B show, respectively, a typical log spectrum and a corresponding root spectrum for the same data, as a means of illustrating using an analogy that can be presented graphically, the differences between a typical log cepstrum and a corresponding root cepstrum. FIGS. 9A and 9B illustrate respectively log and root spectra at three different energy levels. It can be seen that the log spectra are the same shape, but have little dynamic range, whereas the root spectra have a greater dynamic range but change shape with energy. These effects apply also to the log and root Cepstra. Consequently, in this embodiment, the speech energy is normalised, in order to use the root-cepstrum.

Conventional methods of normalising the speech energy use some value based on the total energy as the normalisation value. In clean speech this is equal to the speech energy and is therefore very effective. In noisy conditions this total energy is a non-linear combination of the speech and noise energies. Normalising by the total energy is not effective in this case as, by normalising to the total of the speech plus noise, one effectively scales the speech component to an unknown level, which is dependent on the noise.

Thus, in the following embodiments, a normalisation value that is based on an estimate of the speech level rather than the total level of the combined speech and noise is used.

For a frame of speech (one of a series of finite segments), it is possible to estimate the separate contributions of speech and noise to a reasonable level of accuracy within the spectral (frequency) domain. For example, within voiced speech, the majority of the speech energy is concentrated within equidistant harmonic bands. By identifying the position and breadth of these bands in a given frame, it is possible to largely separate the speech and noise contributions. Thus, in one such embodiment, the speech energy is normalised using the above described results indicating positions of harmonics in a noisy speech signal.

Alternatively, by interpolating between the noise components, a more complete noise estimate is possible, and thus the speech energy may be calculated as the total energy minus the noise energy. A method of interpolating between the noise components is described in a co-filed patent application of the present applicant, identified by applicant's reference CM00772P, whose contents are contained herein by reference.

In a further such embodiment, the estimate of the speech energy level is derived as follows. As described above, in the frequency domain, speech is composed of a series of peaks. These have a much higher amplitude than the rest of the speech, and are usually visible in noise, even in quite low signal to noise ratios. Since most of the energy in speech is concentrated in the peaks, the peak values can be used as an estimate of the speech level (this is referred to below as the “peak-approximation method”).

In yet a further such embodiment, the estimate of the speech energy level is derived as follows. Multiple microphones may be used to obtain a continuous estimate of the noise. This noise estimate can then be used in conjunction with the noise interpolation method mentioned above to provide an accurate estimate of the speech level.

In each of the above embodiments, once an estimate of the speech level within a frame is obtained, normalisation may be implemented using any of a number of methods. The normalisation value can be either a linear sum of the speech energy estimate at each frequency (or peak in the case of the “peak-approximation method” of obtaining the energy level), or the root of the sum of the squares, both of which represent conventional aspects of normalisation per se. A further alternative will now be described.

The spectra is normalised using a power-law regulated by a speech-confidence metric. For example, in a noise-only frame some speech confidence measure will be 0%, so one may normalise in a linear fashion. By contrast, in a strong region of voiced speech, confidence may be 100% and so one may normalise in a squared fashion. The effect is to strongly emphasise the speech components of the utterance to the recogniser, whilst still maintaining consistent energy levels. The optimal relationship between confidence level and power-law is derived empirically.

Results

Returning now to the main harmonic-identifying embodiments described earlier, the powerful effect of implementing the present invention is illustrated by the following results.

A spectrogram is a means for showing consecutive spectra from consecutive sampling frames in one view. The abscissa represents time, the ordinate represents frequency, and the intensity or darkness of a point on the spectrogram represents the intensity of a signal at the relevant frequency and time. In other words, one slice through the spectrogram (up from the abscissa i.e. parallel to the ordinate) represents one spectrum of the type shown in FIG. 3, and the spectrogram as a whole represents a large number of these slices placed adjacent in time order.

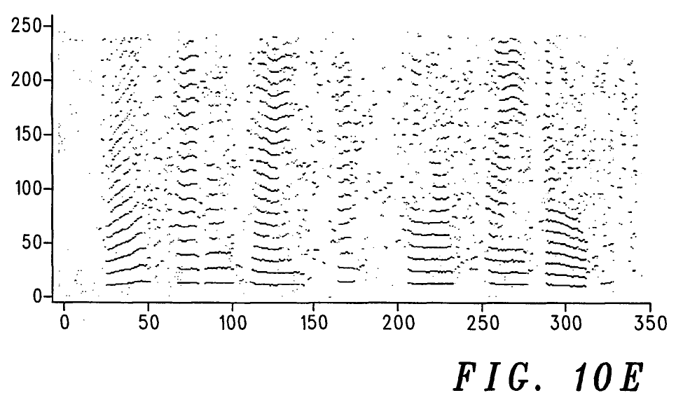

FIG. 10A shows an “ideal” spectrogram for the phrase “Oh-7-3-6-4-3-oh” in clean conditions, i.e. without noise. Individual harmonics can be seen as the dark bands (and their movement up or down with time indicates frame-to-frame harmonic trajectory as discussed earlier). FIG. 10B shows the same phrase in noise, more particularly ETSI standard 5 dB signal to noise ratio (SNR) train noise. The following results are for a signal with noise of the type shown in FIG. 10B.

Firstly, a benefit of the earlier described two-scale differentiation procedure for identifying peaks can be seen from the results of differentiating the FIG. 10B type noisy signal. FIGS. 10C-10E have the same axes as a spectrogram, but in each slice only show peaks of the corresponding spectrum providing that slice, i.e. they are in effect a “binary” plot of all peaks. FIG. 10C shows the outcome using a conventional differentiation process, whereas FIG. 10D shows the outcome using the two-scale differentiation procedure. Positive discrimination of speech peaks compared to peaks formed by noise is clearly achieved.

Secondly, a typical output of the harmonic identification embodiments, in this case the third embodiment with the optional time consistency analysis included, where each peak is individually compared to a threshold and then only those peaks with a score over the threshold are included in a revised version of the signal, is illustrated in FIG. 10E. Recall that FIG. 10C shows all the peak energy values within the recording, including those due to noise. Whilst it is possible to discern the consistent ‘strata-like’ harmonics of voiced speech in FIG. 10C, this is made difficult by the presence of the noise. FIG. 10E shows the outcome of the analysis of the peaks as described previously. It can readily be seen in FIG. 10E that the speech harmonic ‘strata’ have been identified and preserved whilst over 90% of the surrounding noise peaks have been rejected.

To summarise, the above described embodiments provide for a means of identifying speech harmonics in which:

(a) there is no need for high pitch (f₀) accuracy as there is no need to predict long sequences of harmonic positions; and

(b) there is no need for an assumption of harmonic integrity at all points (i.e. that all multiples of f₀ contain only speech, and have not been swamped by noise) as only those harmonics whose values are above the noise floor are identified.

1. A method of processing a speech signal in noise, comprising:
determining a frequency spectrum of a frame of the speech signal;
determining a value of the pitch of the frame of the speech signal; characterised by:
identifying peaks (12, 14, 16, 22, 28, 32) in the spectrum; and
evaluating the peaks (12, 14, 16, 22, 28, 32) individually to determine respective scores for the peaks (12, 14, 16, 22, 28, 32), the score for a peak (12, 14, 16, 22, 28, 32) being a measure of the likelihood that the peak (12, 14, 16, 22, 28, 32) is a harmonic band of the speech signal.

2. A method according to claim 1, wherein each peak (12, 14, 16, 22, 28, 32) is individually evaluated by analysing the frequency position of the peak relative to the frequency position of one or more of the other peaks.

3. A method according to claim 2; wherein the score for a peak (12, 14, 16, 22, 28, 32) under consideration is dependent upon how close other peaks are to a frequency position calculated as one pitch away from the frequency position of the peak under consideration.

4. A method according to claim 3, wherein the evaluating step comprises:
selecting a first peak (22) at a first frequency position (24);
calculating a first calculated frequency position (26) separated from the first frequency position in frequency by the pitch value;
identifying any second peak (28) within a given number of frequency bins of the first calculated frequency position (26); and
allocating a score to the first peak (22) dependent upon the relative frequency position of the second peak (28) compared to the first calculated frequency position (26).

5. A method according to claim 4, further comprising:
calculating a second calculated frequency position (30) separated, in an opposite frequency direction to the first calculated frequency position (26), from the first frequency position (24) in frequency by the pitch value;
identifying any third peak (32) within a given number of frequency bins of the second calculated frequency position (30); and
allocating a score to the first peak (22) dependent upon the relative frequency position of the second peak (28) compared to the first calculated frequency position (26) and the relative frequency position of the third peak (32) compared to the second calculated frequency position (30).

6. A method according to claim 5, wherein the score is allocated according to the closeness of the second and third peaks to the first and second calculated frequency positions respectively and according to whether any variation is in the same or different frequency direction for the second peak (28) compared to the third peak (32).

7. A method according to claim 6, wherein the given number of frequency bins from the first and second calculated frequency positions within which any second or third peak is identified is ± one frequency bin, where + represents increasing/decreasing frequency value, such that the second or third peak may be either (i) one bin higher, (ii) at the correct bin or (iii) one bin lower than the respective calculated frequency position, and (iv) if no peaks are identified within ± one frequency bin then there is respectively no identified second or third peak; and the score is allocated as follows in terms of the second and third peaks:
if both the peaks are at the correct bin, the score is ‘6’;
if one of the peaks is at the correct bin and the other peak is one bin higher or one bin lower, the score is ‘5’;
if both peaks are one bin higher or both peaks are one bin lower, the score is ‘4’;
if one peak is one bin higher and the other peak is one bin lower, the score is ‘3’;
if one peak is correct and there is no other peak identified, the score is ‘2’;
if one peak is one bin higher or one bin lower, and there is no other peak identified, the score is ‘1’; and
if neither peak is identified, the score is ‘0’.

8. A method according to claim 2, wherein the evaluating step comprises:
determining the fundamental frequency position;
calculating a first calculated frequency position separated from the fundamental frequency position by the pitch;
seeking a first peak within a given number of frequency bins of the first calculated frequency position; and
if such a first peak is found, allocating a score to the first peak dependent upon the relative frequency position of the first peak compared to the first calculated frequency position.

9. A method according to claim 8, further comprising, if such a first peak is found:
calculating a second calculated frequency position separated from the frequency position of the first peak by the pitch;
seeking a second peak within a given number of frequency bins of the second calculated frequency position; and
if such a second peak is found, allocating a score to the second peak dependent upon the relative frequency position of the second peak compared to the first calculated frequency position.

10. A method according to claim 8 or 9, further comprising, if such a first peak is not found:
calculating a second calculated frequency position separated from the fundamental frequency position by twice the pitch;
seeking a second peak within a given number of frequency bins of the second calculated frequency position; and
if such a second peak is found, allocating a score to the second peak dependent upon the relative frequency position of the second peak compared to the second calculated frequency position.

11. A method according to claim 9 or 10, further comprising repeating the steps in corresponding fashion for further peaks and/or multiples of the pitch until the whole spectrum has been analysed.

12. A method according to any of claims 8 to 11, wherein the given number of frequency bins which the respective peaks are required to be within the respective calculated frequency position is ± one frequency bin, where ± represents increasing/decreasing frequency value, such that the respective peak may be either at the respective calculated frequency position in which case the peak is allocated a relatively higher score or ± one frequency bin of the respective calculated frequency position in which case the peak is allocated a relatively lower score.

13. A method according to any of claims 3 to 7 further comprising the steps of the method of any of claims 8 to 12, wherein the score for a peak is a score provided by combining, for example by adding, the respective scores for the peak from each of the two methods.

14. A method according to any preceding claim, further comprising performing an iterative process in which the positions found for identified harmonics are used to update the value of the pitch and the updated value of the pitch is then used in a refined determination of the positions of the harmonics.

15. A method according to any preceding claim, wherein the score for a peak is modified by analysing the consistency of the score for the peak in the present frame with the score for the corresponding peak in one or more previous and/or one or more subsequent frames.

16. A method according to claim 15, wherein the score is modified by adding to the score for the peak in the present frame the score for the corresponding peak in the one or more preceding and/or one or more subsequent frames, for those preceding and/or subsequent frames which fall within an allowable frame to frame speech harmonic trajectory.

17. A method according to claim 16, wherein the score is modified by adding to the score for the peak in the present frame the score for the corresponding peak in the immediately preceding frame and the immediately subsequent frame, and the allowable frame to frame speech harmonic trajectory is that the corresponding peaks in the previous and subsequent frames are only allowed to be at the same frequency bin or at ± one frequency bin from the same frequency bin as the peak in the present frame.

18. A method according to any preceding claim, wherein the score for a peak is compared to a threshold value to determine whether the peak is to be treated as a harmonic band of the speech signal.

19. A method according to claim 18, further comprising using a separate speech/non-speech detector to estimate whether the frame is speech or non-speech, and wherein the threshold value is varied according to whether the estimate is speech or non-speech.

20. A method according to claim 18 or 19, wherein the speech signal is reproduced in a form containing only the harmonic bands or frames that are to be treated as speech in view of the comparison of their score with the threshold.

21. A method according to any of claims 1 to 18, wherein the score for a peak is used as a speech-confidence indicator for further processing of the peak.

22. A method according to any preceding claim, wherein the step of identifying peaks in the spectrum comprises differentiating the frequency spectrum with respect to frequency using two scales, the first scale being over a higher number of frequency bins than the second scale, and weighting the results from the two scales such that the differentiation using the first scale identifies significant speech peaks and the differentiation using the second scale improves the precision of the calculation of the frequency position of the identified peak.

23. A method according to any preceding claim, further comprising using the resulting harmonic band data in at least one of the following group of processes:
(i) automatic speech recognition;
(ii) front-end processing in distributed automatic speech recognition;
(iii) speech enhancement;
(iv) echo cancellation;
(v) speech coding.

24. A method according to any preceding claim, further comprising estimating the amount of speech energy in the frame as the energy contained in the identified speech harmonics.

25. A method according to claim 24, further comprising using the estimated speech energy of the frame to normalise the speech energy of the frame.

26. A method according to claim 25, wherein the speech energy of the frame is normalised using a power-law regulated by a speech-confidence metric.

27. A method according to claim 25 or 26, further comprising deriving a root-cepstrum of the frame using the normalised speech energy of the frame, and using the root-cepstrum of the frame to perform an automatic speech recognition process on the frame.

28. A method of performing automatic speech recognition on a speech signal in noise, comprising normalising the speech energy level of the signal and deriving a root-cepstrum using the normalised speech energy level.

29. A method of identifying peaks (12, 14, 16) in a frequency spectrum of a frame of a speech signal, comprising:
differentiating the frequency spectrum with respect to frequency using two scales, the first scale being over a higher number of frequency bins than the second scale, and
weighting the results from the two scales such that the differentiation using the first scale identifies significant speech peaks and the differentiation using the second scale improves the precision of the calculation of the frequency position of the identified peak.

30. A storage medium storing processor-implementable instructions for controlling one or more processors to carry out the method of any of claims 1 to 29.

31. Apparatus adapted to implement the method of any of claims 1 to 29.
